(19) United States
(12) Patent Application Publication
(10) Pub. No.: US 2011/0307163 A1
(43) Pub. Date: Dec. 15, 2011

(54) CONTROLLER OF INTERNAL COMBUSTION ENGINE

(75) Inventors: Takehiko KATO, Nukata-gun (JP); Masahiro SHIGENAGA, Okazaki-city (JP); Masatoshi BASAKI, Nukata (JP); Kimitaka SAITO, Nagoya-city (JP); Makoto MIWA, Kariya-city (JP)

(73) Assignees: NIPPON SOKEN, INC., Nishio-city (JP); DENSO CORPORATION, Kariya-city (JP)

(21) Appl. No.: 13/160,855

(22) Filed: Jun. 15, 2011

(30) Foreign Application Priority Data
Jun. 15, 2010 (JP) 2010-135648

(51) Int. Cl. F02D 41/30; F02D 28/00

(52) U.S. Cl. 701/104

(57) ABSTRACT

A controller performs compression self-ignition combustion control for combusting a mixture gas by injecting fuel into a cylinder in a negative valve overlapping period (NVO period), in which both of an exhaust valve and an intake valve are closed, and by causing self-ignition of the mixture gas using compression in a compression stroke. If knocking is detected during the above control, the controller performs knock suppression control for correcting a fuel injection quantity in the NVO period to suppress the knocking. If a pressure increase rate of cylinder pressure during the combustion is lower than a threshold value, the controller performs increase correction of the fuel injection quantity in the NVO period. If the pressure increase rate is equal to or higher than the threshold value, the controller performs decrease correction of the fuel injection quantity in the NVO period.

### CROSS REFERENCE TO RELATED APPLICATION

This application is based on and incorporates herein by reference Japanese Patent Application No. 2010-135648 filed on Jun. 15, 2010.

### BACKGROUND OF THE INVENTION

1. Field of the Invention

The present invention relates to a controller of an internal combustion engine having a function to combust a mixture gas by injecting fuel into a cylinder in a negative valve overlapping period of the internal combustion engine and by causing self-ignition of the mixture gas using compression in a compression stroke.

2. Description of Related Art

There is a technology that performs following compression self-ignition combustion control aiming at reduction of a fuel consumption, reduction of a NOx emission quantity and the like of an internal combustion engine, for example, as described in Patent document 1 (JP-A-2001-207888). That is, in the compression self-ignition combustion control, a negative valve overlapping period, in which both of an exhaust valve and an intake valve are closed in a latter half of an exhaust stroke of the internal combustion engine, is set. Fuel is injected into a cylinder in the negative valve overlapping period, and second fuel injection is performed in an intake stroke or a compression stroke. Self-ignition of a mixture gas is caused by compression in the compression stroke to combust the mixture gas. Patent document 1 also proposes to suppress knocking by delaying fuel injection timing in the negative valve overlapping period if the knocking is detected during the compression self-ignition combustion control.

The compression self-ignition combustion control realizes stable compression self-ignition combustion by injecting the fuel into the cylinder in the negative valve overlapping period and by reforming the fuel into a condition causing the self-ignition more easily. However, if a fuel injection quantity in the negative valve overlapping period fluctuates due to some causes, there is a possibility that the knocking occurs. If the fuel injection quantity in the negative valve overlapping period is larger than an appropriate range, the combustion becomes sharp and the knocking becomes more apt to occur. If the fuel injection quantity in the negative valve overlapping period is smaller than the appropriate range, the combustion becomes slow and the knocking becomes more apt to occur in a later stage of the combustion.

The technology of Patent document 1 delays the fuel injection timing in the negative valve overlapping period if the knocking is detected during the compression self-ignition combustion control. Therefore, when the knocking occurs because the fuel injection quantity in the negative valve overlapping period is small and the combustion is slow, a combustion state further worsens because of the delay of the fuel injection timing. As a result, there is a possibility that the occurrence of the knocking lengthens or magnitude of the knocking increases. There is a possibility that the internal combustion engine is damaged or a driver feels uncomfortable.

### SUMMARY OF THE INVENTION

It is an object of the present invention to provide a controller of an internal combustion engine capable of effectively suppressing knocking during compression self-ignition combustion control.

According to a first example aspect of the present invention, a controller of an internal combustion engine has a combustion controlling section for performing compression self-ignition combustion control for combusting a mixture gas by injecting fuel into a cylinder in a negative valve overlapping period (NVO period), in which both of an exhaust valve and an intake valve are closed at least in a latter half of an exhaust stroke of the internal combustion engine, and by causing self-ignition of the mixture gas using compression in a compression stroke. The controller has a knock determining section for determining whether knocking is caused during the compression self-ignition combustion control. When the knock determining section detects the knocking during the compression self-ignition combustion control, the combustion controlling section performs knock suppression control for correcting a fuel injection quantity in the negative valve overlapping period such that the knocking is suppressed.

With such the construction, when the knocking is detected during the compression self-ignition combustion control, the knock suppression control for correcting the fuel injection quantity in the NVO period (negative valve overlapping period) into the appropriate range (range where knocking hardly occurs) is performed. Thus, the knocking during the compression self-ignition combustion control can be suppressed effectively.

For example, as shown in FIGS. 2 and 3, if the fuel injection quantity in the NVO period is larger than the appropriate range during the compression self-ignition combustion control, the combustion becomes sharp and an increase rate of cylinder pressure during the combustion increases. Accordingly, a pressure vibration due to the knocking becomes more apt to occur near the maximum cylinder pressure (as shown by solid line “a” in FIG. 3). If the fuel injection quantity in the NVO period is smaller than the appropriate range, the combustion becomes slow and the increase rate of the cylinder pressure during the combustion decreases. However, the pressure vibration due to the knocking becomes more apt to occur in the later stage of the combustion (as shown by solid line “c” in FIG. 3). This is thought to be a phenomenon caused by the self-ignition of the mixture gas having existed in an unburned state for a long time due to the initial slow combustion. In FIG. 3, a solid line “b” shows a case where the fuel injection quantity in the NVO period is middle and the knocking is not caused.

The combustion state changes and the increase rate of the cylinder pressure during the combustion changes depending on the fuel injection quantity in the NVO period. Therefore, the increase rate of the cylinder pressure during the combustion serves as a parameter for determining the combustion state or the fuel injection quantity in the NVO period.

Therefore, according to a second example aspect of the present invention, the controller further has a pressure increase rate calculating section for calculating an increase rate of cylinder pressure (pressure increase rate) during the combustion while the compression self-ignition combustion control is performed. The combustion controlling section performs increase correction of the fuel injection quantity in the negative valve overlapping period if the pressure increase rate calculated by the pressure increase rate calculating section is lower than a predetermined threshold value during the knock suppression control. The combustion controlling section performs decrease correction of the fuel injection quantity in the negative valve overlapping period if the pressure increase rate is equal to or higher than the threshold value during the knock suppression control.

That is, if the pressure increase rate is lower than the threshold value when the knock suppression control is performed, it is determined that the fuel injection quantity in the NVO period is smaller than the appropriate range and that the combustion is slow and the knocking is caused. Then, the increase correction of the fuel injection quantity in the NVO period is performed. Thus, the fuel injection quantity in the NVO period can be controlled into the appropriate range. If the pressure increase rate is equal to or higher than the threshold value, it is determined that the fuel injection quantity in the NVO period is larger than the appropriate range and that the combustion is sharp and the knocking is caused. Then, the decrease correction of the fuel injection quantity in the NVO period is performed. Thus, the fuel injection quantity in the NVO period can be controlled into the appropriate range. With such the construction, the fuel injection quantity in the NVO period can be quickly controlled into the appropriate range in accordance with the pressure increase rate.

According to a third example aspect of the present invention, the combustion controlling section performs the decrease correction of the fuel injection quantity in the negative valve overlapping period when the knock suppression control is performed. The combustion controlling section performs the increase correction of the fuel injection quantity in the negative valve overlapping period if the knocking cannot be suppressed even though the decrease correction is performed.

That is, when the knock suppression control is performed, first, it is assumed that the fuel injection quantity in the NVO period is larger than the appropriate range (i.e., combustion is sharp and knocking is caused), and the decrease correction of the fuel injection quantity in the NVO period is performed. If the knocking is suppressed by the decrease correction, it is determined that the assumption is correct (i.e., fuel injection quantity in NVO period is larger than appropriate range). Then, the fuel injection quantity in the NVO period is maintained at the corrected and decreased state as it is, whereby the fuel injection quantity in the NVO period can be controlled in the appropriate range. If the knocking cannot be suppressed even though the decrease correction of the fuel injection quantity in the NVO period is performed, it is determined that the assumption is incorrect (i.e., fuel injection quantity in NVO period is smaller than appropriate range). Then, the increase correction of the fuel injection quantity in the NVO period is performed, whereby the fuel injection quantity in the NVO period can be controlled into the appropriate range.

According to a fourth example aspect of the present invention, the combustion controlling section performs the increase correction of the fuel injection quantity in the negative valve overlapping period when the knock suppression control is performed. The combustion controlling section performs the decrease correction of the fuel injection quantity in the negative valve overlapping period if the knocking cannot be suppressed even though the increase correction is performed.

That is, when the knock suppression control is performed, first, it is assumed that the fuel injection quantity in the NVO period is smaller than the appropriate range (i.e., combustion is slow and knocking is caused). Then, the increase correction of the fuel injection quantity in the NVO period is performed. If the knocking is suppressed by the increase correction, it is determined that the assumption is correct (i.e., fuel injection quantity in NVO period is smaller than appropriate range). Then, the fuel injection quantity in the NVO period is maintained at the corrected and increased state as it is. Thus, the fuel injection quantity in the NVO period can be controlled in the appropriate range. If the knocking cannot be suppressed even though the increase correction of the fuel injection quantity in the NVO period is performed, it is determined that the assumption is incorrect (i.e., fuel injection quantity in NVO period is larger than appropriate range). Then, the decrease correction of the fuel injection quantity in the NVO period is performed. Thus, the fuel injection quantity in the NVO period can be controlled into the appropriate range.

In the both cases of the third and fourth example aspects, there is no need to obtain the pressure increase rate (increase rate of cylinder pressure during combustion). Therefore, the sensor for sensing the cylinder pressure can be eliminated, thereby fulfilling requirement for cost reduction.

According to a fifth example aspect of the present invention, when the knocking cannot be suppressed even though the knock suppression control is performed, the combustion controlling section stops the compression self-ignition combustion control and switches to spark ignition combustion control for combusting the mixture gas by igniting the mixture gas using a spark discharge from a spark plug.

That is, if the knocking cannot be suppressed even though the knock suppression control is performed, it is determined that the knocking cannot be suppressed if the compression self-ignition combustion control is maintained. Then, the compression self-ignition combustion control is stopped and switched to the spark ignition combustion control, thereby suppressing the knocking. Thus, the knocking can be surely avoided.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a diagram showing a schematic construction of an engine control system according to a first embodiment of the present invention;

FIG. 2 is a characteristic diagram showing a relationship among a fuel injection quantity in a NVO period, a knocking occurrence frequency and a pressure increase rate during compression self-ignition control according to the first embodiment;

FIG. 3 is a diagram illustrating a behavior of cylinder pressure during the compression self-ignition combustion control according to the first embodiment;

FIG. 4 is a first part of a flowchart illustrating a processing flow of a combustion control routine according to the first embodiment;

FIG. 5 is a second part of a flowchart illustrating the processing flow of the combustion control routine according to the first embodiment;

FIG. 6 is a diagram illustrating knock suppression control according to a second embodiment of the present invention; and

FIG. 7 is a flowchart illustrating a substantial part of a processing flow of a combustion control routine according to the second embodiment.

### DETAILED DESCRIPTION OF EXAMPLE EMBODIMENT

Hereafter, embodiments of the present invention will be described with reference to the drawings.

### First Embodiment

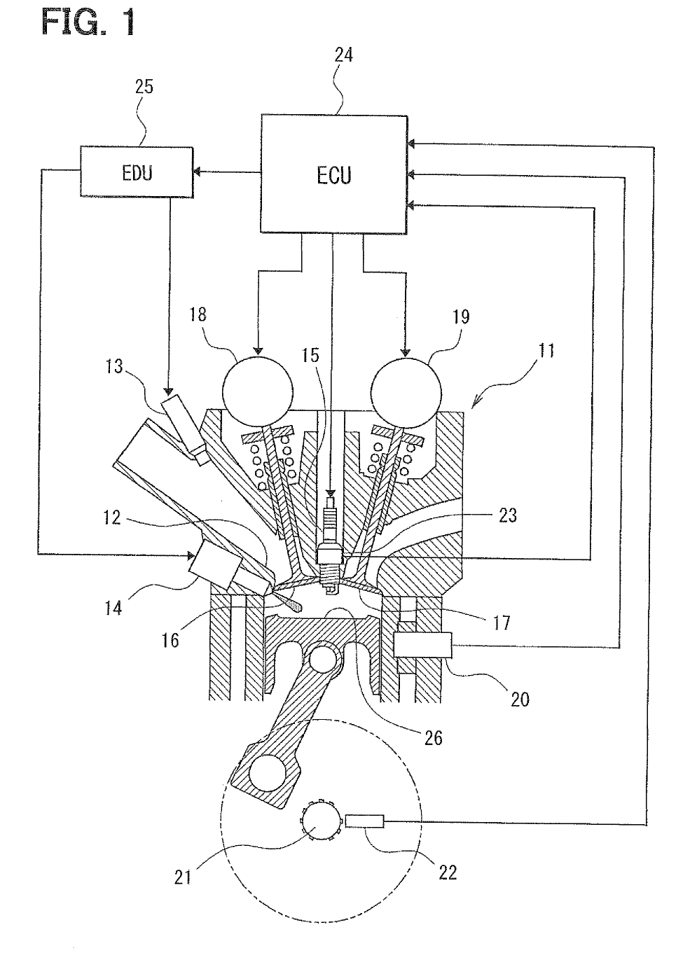

A first embodiment of the present invention will be described with reference to FIGS. 1 to 5. First, a general construction of an engine control system will be explained with reference to FIG. 1. in an engine 11 (internal combustion engine), inlet-port-injection injectors 13 for injecting fuel toward inlet ports 12 are attached for respective cylinders. In addition, direct-injection injectors 14 for injecting the fuel directly into the cylinders are attached for the respective cylinders. Spark plugs 15 are attached to a cylinder head of the engine 11 for the respective cylinders.

The engine 11 has an intake side variable valve timing device 18 for changing valve timings (opening-closing timings) of intake valves 16 and an exhaust side variable valve timing device 19 for changing valve timings of exhaust valves 17.

A coolant temperature sensor (not shown) for sensing coolant temperature and a knock sensor 20 (vibration acceleration sensor) for sensing a knocking vibration are attached to a cylinder block of the engine 11. A crank angle sensor 22 is provided close to an outer periphery of a crankshaft 21 of the engine 11 and outputs a pulse signal every time the crankshaft 21 rotates by a predetermined crank angle. A crank angle and engine rotation speed are sensed based on the output signal of the crank angle sensor 22.

The engine 11 has one or more cylinder pressure sensors 23 for sensing cylinder pressure of the respective cylinders (or specific cylinder(s)). The cylinder pressure sensor 23 may be a sensor integral with the spark plug 15. Alternatively, the cylinder pressure sensor 23 may be a sensor section, which is a body separate from the spark plug 15 and is attached to face an inside of a combustion chamber.

Outputs of the above-described various sensors are inputted to an electronic control circuit 24 (ECU). The ECU 24 is constituted mainly by a microcomputer. The ECU 24 executes various kinds of engine control programs stored in incorporated ROM (storage medium) to control a fuel injection quantity, ignition timing, a throttle opening degree (or intake air quantity) and the like according to an engine operation state. At that time, the ECU 24 calculates injection pulses of the injectors 13, 14 based on a request fuel injection quantity and the like corresponding to the engine operation state. The ECU 24 outputs drive currents to the injectors 13, 14 based on the injection pulses of the injectors 13, 14 via EDU 25.

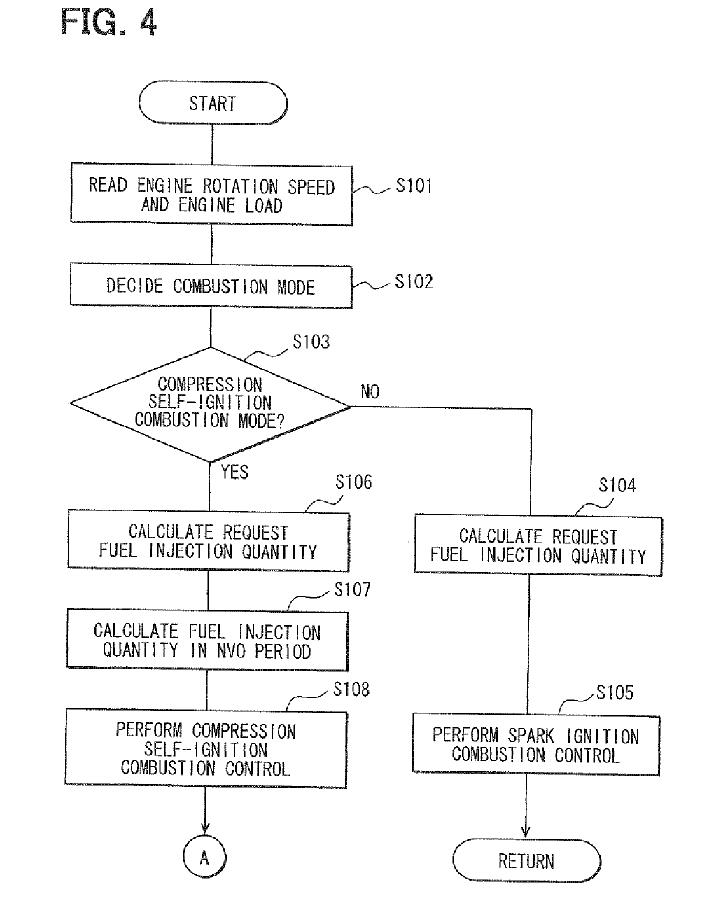

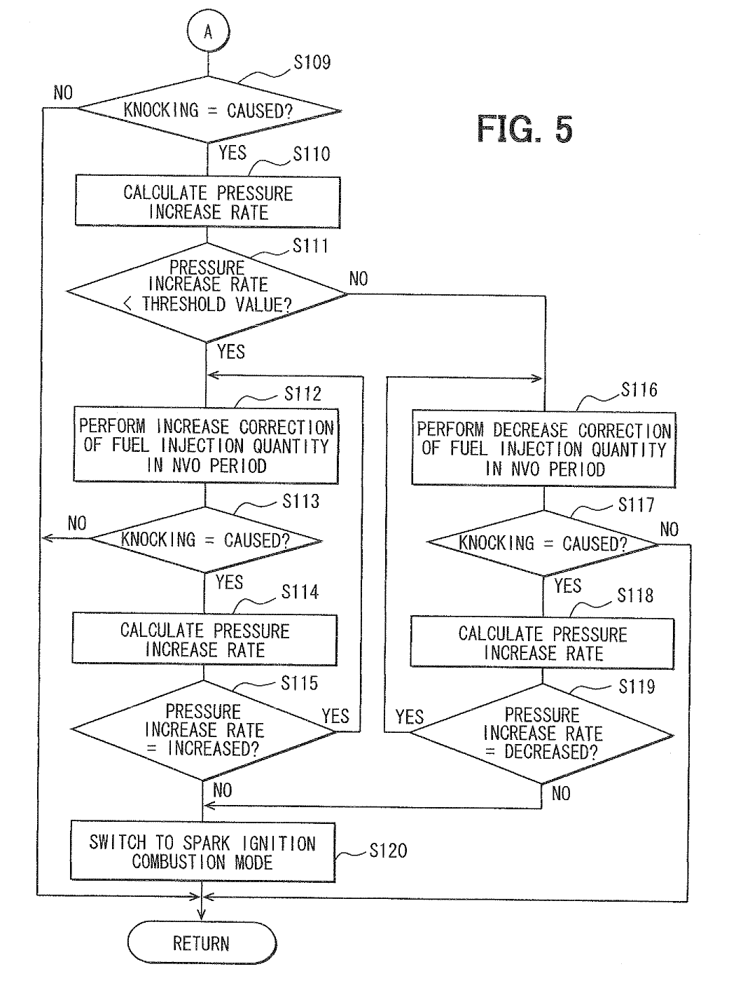

The ECU 24 executes a combustion control routine shown in FIGS. 4 and 5. Thus, when an engine operation range is in a predetermined compression self-ignition combustion range, the ECU 24 performs compression self-ignition combustion control for combusting a mixture gas by causing self-ignition of the mixture gas using compression in a compression stroke. When the engine operation range is in a predetermined spark ignition combustion range, the ECU 24 performs spark ignition combustion control for combusting the mixture gas by igniting the mixture gas using a spark discharge from the spark plug 15.

In the compression self-ignition combustion control, first, the variable valve timing devices 18, 19 on the intake side and the exhaust side are controlled to provide a negative valve overlapping period (referred to as NVO period, hereafter), in which both of the exhaust valve 17 and the intake valve 16 are closed at least in a latter half of an exhaust stroke (e.g., period from latter half of exhaust stroke to former half of intake stroke). In the NVO period, a high-temperature combustion gas remaining in the cylinder is compressed by ascent of a piston 26 in the latter half of the exhaust stroke. Therefore, the inside of the cylinder is brought to a high-temperature and high-pressure state.

The fuel is injected into the cylinder by the direct-injection injector 14 in the NVO period. The fuel injected into the cylinder in the NVO period is exposed to the high temperature and the high pressure in the cylinder. Thus, the fuel is reformed into a condition to start a reaction in a preliminary stage of the combustion and to cause the self-ignition more easily.

Then, in the intake stroke, the fuel is injected by the inlet-port-injection injector 13 or the direct-injection injector 14. Alternatively, the fuel is injected by the direct-injection injector 14 in the compression stroke. The mixture gas is formed in the cylinder from the fuel injected in the intake stroke or the compression stroke and the reformed fuel (i.e., fuel injected in NVO period). Thereafter, when the temperature in the cylinder becomes high due to the compression in the compression stroke, the reformed fuel in the mixture gas causes the self-ignition and functions as an ignition source, whereby the mixture gas is combusted. Thus, the compression self-ignition combustion of the mixture gas is achieved.

Depending on the engine operation range or the like, the second fuel injection (fuel injection in intake stroke or compression stroke) after the fuel injection in the NVO period may be eliminated, and the compression self-ignition combustion control may be performed only with the fuel injection in the NVO period.

As mentioned above, in the compression self-ignition combustion control, the fuel is injected into the cylinder in the NVO period to reform the fuel into a condition causing the self-ignition more easily, thereby realizing the stable compression self-ignition combustion. However, if the fuel injection quantity in the NVO period fluctuates due to some causes, there is a possibility that the knocking (knock) occurs.

As a countermeasure, the ECU 24 according to the present embodiment determines existence or nonexistence of the knocking based on the output signal of the knock sensor 20 (or cylinder pressure sensor 23) during the compression self-ignition combustion control. If the knocking is detected, the ECU 24 performs nock suppression control for correcting the fuel injection quantity in the NVO period such that the knocking is suppressed. Thus, the fuel injection quantity in the NVO period is controlled into an appropriate range (i.e., range where knocking hardly occurs).

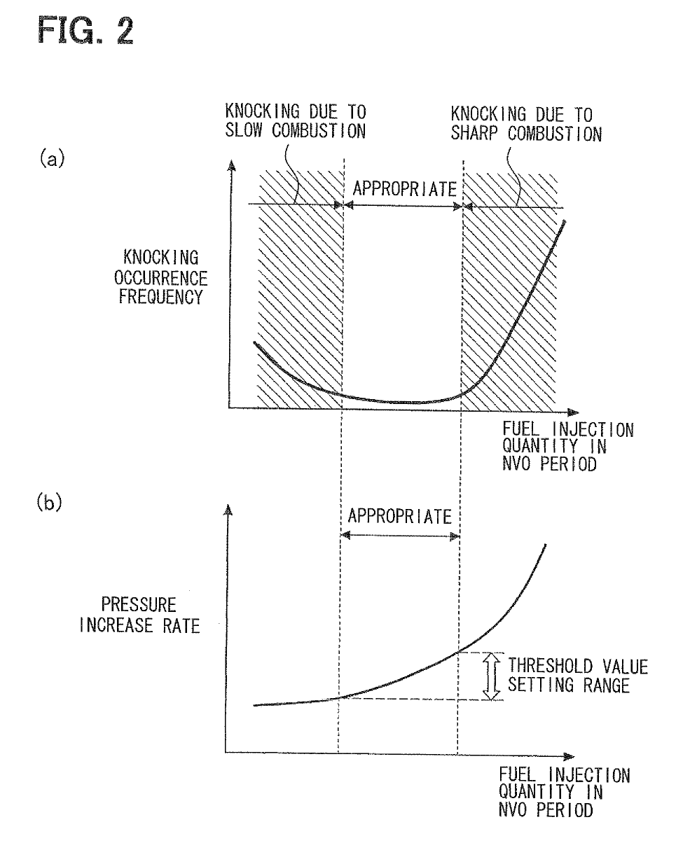

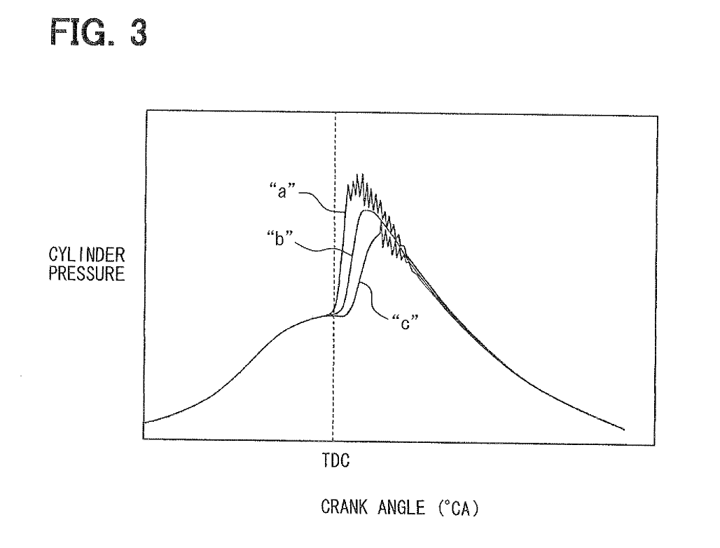

For example, as shown in FIGS. 2 and 3, if the fuel injection quantity in the NVO period is larger than the appropriate range during the compression self-ignition combustion control, the combustion becomes sharp and an increase rate of the cylinder pressure during the combustion increases. As a result, a pressure vibration due to the knocking becomes more apt to occur near the maximum cylinder pressure. If the fuel injection quantity in the NVO period is smaller than the appropriate range, the combustion becomes slow and the increase rate of the cylinder pressure during the combustion decreases. However, the pressure vibration due to the knocking becomes more apt to occur in the later stage of the combustion. This is thought to be a phenomenon caused by the self-ignition of the mixture gas having existed for a long time in an unburned state due to the slow initial combustion.

At that time, the combustion state changes and the increase rate of the cylinder pressure during the combustion changes depending on the fuel injection quantity in the NVO period. Therefore, the increase rate of the cylinder pressure during the combustion serves as a parameter for determining the combustion state or the fuel injection quantity in the NVO period.

Focusing attention on this point, according to the first embodiment, the increase rate of the cylinder pressure (referred to as pressure increase rate, hereafter) during the combustion is calculated based on the output signal of the cylinder pressure sensor 32 while the compression self-ignition combustion control is performed. When the knock suppression control is performed, if the pressure increase rate is lower than a predetermined threshold value, it is determined that the fuel injection quantity in the NVO period is smaller than the appropriate range and that the combustion is slow and the knocking is caused. In this case, increase correction of the fuel injection quantity in the NVO period is performed to control the fuel injection quantity in the NVO period into the appropriate range. If the pressure increase rate is equal to or higher than the threshold value, it is determined that the fuel injection quantity in the NVO period is larger than the appropriate range and that the combustion is sharp and the knocking is caused. In this case, decrease correction of the fuel injection quantity in the NVO period is performed to control the fuel injection quantity in the NVO period into the appropriate range.

Next, processing contents of the combustion control routine shown in FIGS. 4 and 5 and executed by the ECU 24 according to the present embodiment will be explained. The combustion control routine shown in FIGS. 4 and 5 is executed repeatedly while a power supply of the ECU 24 is ON and functions as the combustion controlling section of the present invention. If the routine is started, first in S101 (S means “Step”), the engine rotation speed, an engine load (e.g., intake air quantity or intake pipe pressure) and the like are read. Then, the process proceeds to S102, in which it is determined whether the present engine operation range (e.g., engine rotation speed, engine load and the like) is in a compression self-ignition combustion range or in a spark ignition combustion range. If the present engine operation range is in the compression self-ignition combustion range, a combustion mode is set to a compression self-ignition combustion mode. If the present engine operation range is in the spark ignition combustion range, the combustion mode is set to a spark ignition combustion mode.

Thereafter, the process proceeds to S103, in which it is determined whether the present combustion mode is the compression self-ignition combustion mode. If it is determined in S103 that the present combustion mode is not the compression self-ignition combustion mode (i.e., combustion mode is spark ignition combustion mode), the process proceeds to S104, in which the request fuel injection quantity corresponding to the present engine operation state (e.g., engine rotation speed, engine load and the like) is calculated with a map, a formula or the like. Then, the process proceeds to S105, in which the spark ignition combustion control is performed to combust the mixture gas by injecting the fuel in the intake stroke or the compression stroke and by igniting the mixture gas using the spark discharge form the ignition plug 15.

If it is determined in S103 that the combustion mode is the compression self-ignition combustion mode, the process proceeds to S106, in which the request fuel injection quantity corresponding to the present engine operation state (e.g., engine rotation speed, engine load and the like) is calculated with a map, a formula or the like. Then, the process proceeds to S107, in which the fuel injection quantity in the NVO period corresponding to the present engine operation state (e.g., engine rotation speed, engine load and the like) is calculated with a map, a formula or the like. A value obtained by subtracting the fuel injection quantity in the NVO period from the request fuel injection quantity is the fuel injection quantity in the intake stroke or the compression stroke.

Then, the process proceeds to S108, in which the compression self-ignition combustion control is performed to combust the mixture gas by controlling the variable valve timing devices 18, 19 such that the NVO period is provided, by injecting the fuel into the cylinder in the NVO period, by performing the second fuel injection in the intake stroke or the compression stroke, and by causing the self-ignition of the mixture gas using the compression in the compression stroke.

Then, the process proceeds to S109 of FIG. 5, in which it is determined whether the knocking is caused based on the output signal of the knock sensor 20 (or cylinder pressure sensor 23) in a predetermined period (e.g., period of several cycles) about all combustion cycles. In this case, for example, vibration magnitude of a specific frequency range is measured based on the output signal of the knock sensor 20 (or cylinder pressure sensor 23) and is compared with a predetermined determination value to determine the existence or nonexistence of the knocking. The determination method of the knocking may be changed arbitrarily.

If it is determined in S109 that the knocking is not caused (i.e., there is no knocking), the routine is ended without performing processing from S110 related to the knock suppression control.

If it is determined in S109 that the knocking is caused (there is knocking), the processing from S110 related to the knock suppression control is performed as follows.

First in S110, the pressure increase rate (increase rate of cylinder pressure during combustion) is calculated for all the combustion cycles based on the output signal of the cylinder pressure sensor 23. In this case, for example, the increase amount of the cylinder pressure per unit crank angle (or unit time) in a predetermined crank angle range near TDC (top dead center) is calculated as the pressure increase rate. The calculation method of the pressure increase rate may be changed arbitrarily.

Then, the process proceeds to S111, in which it is determined whether the pressure increase rate is lower than a predetermined threshold value. For example, as shown in a part (b) of FIG. 2, the threshold value is set in a range between the pressure increase rate corresponding to the upper limit value of the appropriate range of the fuel injection quantity in the NVO period and the pressure increase rate corresponding to the lower limit value of the appropriate range of the fuel injection quantity in the NVO period. The threshold value is set beforehand based on experimental data, design data and the like and stored in the ROM of the ECU 24. The threshold value may be changed according to the engine operation state (e.g., engine rotation speed, engine load or coolant temperature) and the like.

When it is determined in S111 that the pressure increase rate is lower than the threshold value, it is determined that the fuel injection quantity in the NVO period is smaller than the appropriate range and that the combustion is slow and the knocking is caused. In this case, the process proceeds to S112, in which the fuel injection quantity in the NVO period is corrected and increased by a predetermined quantity.

Then, the process proceeds to S113, in which it is determined whether the knocking is caused based on the output signal of the knock sensor 20 (or cylinder pressure sensor 23) in a predetermined period (e.g., period of several cycles). If it is determined that the knocking is still caused, the process proceeds to S114, in which the pressure increase rate is calculated based on the output signal of the cylinder pressure sensor 23. Then, the process proceeds to S115, in which it is determined whether the pressure increase rate has increased from the previous value. If it is determined that the pressure increase rate has increased, the process returns to S112 to repeat the processing for further correcting and increasing the fuel injection quantity in the NVO period by the predetermined quantity.

Thereafter, when it is determined in S113 that the knocking is not caused (i.e., knocking is suppressed), it is determined that the fuel injection quantity in the NVO period has been corrected into the appropriate range by the increase correction. Then, the routine is ended. In this case, if the engine 11 is in a steady operation state, the fuel injection quantity in the NVO period after the increase correction is maintained.

If it is determined in S113 that the knocking is caused and it is determined in S115 that the pressure increase rate has not increased even though the increase correction of the fuel injection quantity in the NVO period is performed, it is determined that the knocking cannot be suppressed if the compression self-ignition combustion control is maintained. Therefore, in this case, the process proceeds to S120, in which the combustion mode is compulsorily changed into the spark ignition combustion mode. Thus, the compression self-ignition combustion control is stopped and switched to the spark ignition combustion control, thereby suppressing the knocking.

If it is determined in S111 that the pressure increase rate is equal to or higher than the threshold value, it is determined that the fuel injection quantity in the NVO period is larger than the appropriate range and that the combustion is sharp and the knocking is caused. In this case, the process proceeds to S116, in which the fuel injection quantity in the NVO period is corrected and decreased by a predetermined quantity.

Thereafter, the process proceeds to S117, in which it is determined whether the knocking is caused based on the output signal of the knock sensor 20 (or cylinder pressure sensor 23) in the predetermined period (e.g., period of several cycles). If it is determined that the knocking is caused, the process proceeds to S118, in which the pressure increase rate is calculated based on the output signal of the cylinder pressure sensor 23. Then, the process proceeds to S119, in which it is determined whether the pressure increase rate has decreased from the previous value. If it is determined that the pressure increase rate has decreased, the process returns to S116 to repeat the processing for further correcting and decreasing the fuel injection quantity in the NVO period by the predetermined quantity.

Thereafter, when it is determined in S117 that the knocking is not caused (i.e., knocking is suppressed), it is determined that the fuel injection quantity in the NVO period has been corrected into the appropriate range by the decrease correction, and the routine is ended. In this case, if the engine 11 is in the steady operation state, the fuel injection quantity in the NVO period after the decrease correction is maintained.

If it is determined in S117 that the knocking is caused and it is determined in S119 that the pressure increase rate has not decreased even though the decrease correction of the fuel injection quantity in the NVO period is performed, it is determined that the knocking cannot be suppressed if the compression self-ignition combustion control is maintained, and the process proceeds to S120. In S120, the combustion mode is compulsorily changed to the spark ignition combustion mode. Thus, the compression self-ignition combustion control is stopped and switched to the spark ignition combustion control, thereby suppressing the knocking.

The processing of S109, S113 and S117 functions as the knock determining section of the present invention. The processing of S110, S114 and S118 functions as the pressure increase rate calculating section of the present invention.

According to the above-described first embodiment, when the knocking is detected during the compression self-ignition combustion control, the knock suppression control for correcting the fuel injection quantity in the NVO period such that the knocking is suppressed is performed. Accordingly, the fuel injection quantity in the NVO period can be controlled into the appropriate range (i.e., range where knocking hardly occurs) and the knocking during the compression self-ignition combustion control can be suppressed effectively.

Moreover, according to the first embodiment, attention is focused on the fact that the pressure increase rate (increase rate of cylinder pressure during combustion) serves as the parameter for determining the combustion state or the fuel injection quantity in the NVO period. Therefore, when the pressure increase rate is lower than the threshold value during the knock suppression control, it is determined that the fuel injection quantity in the NVO period is smaller than the appropriate range and that the combustion is slow and the knocking is caused. In this case, the increase correction of the fuel injection quantity in the NVO period is performed. When the pressure increase rate is equal to or higher than the threshold value, it is determined that the fuel injection quantity in the NVO period is larger than the appropriate range and that the combustion is sharp and the knocking is caused. In this case, the decrease correction of the fuel injection quantity in the NVO period is performed. Thus, the fuel injection quantity in the NVO period is controlled into the appropriate range. Accordingly, the fuel injection quantity in the NVO period can be quickly controlled into the appropriate range according to the pressure increase rate.

If the knocking occurs (i.e., knocking cannot be suppressed) even though the knock suppression control is performed to correct the fuel injection quantity in the NVO period, it is determined that the knocking cannot be suppresses while maintaining the compression self-ignition combustion control. Therefore, in this case, the compression self-ignition combustion control is stopped and switched to the spark ignition combustion control, thereby suppressing the knocking. Thus, the knocking can be surely avoided.

In the above-described first embodiment, the fuel injection quantity in the NVO period is corrected according to the pressure increase rate (increase rate of cylinder pressure during combustion) during the knock suppression control. The present invention is not limited thereto. Alternatively, for example, the fuel injection quantity in the NVO period may be corrected according to an increase amount, a peak value or the like of the cylinder pressure during the combustion.

### Second Embodiment

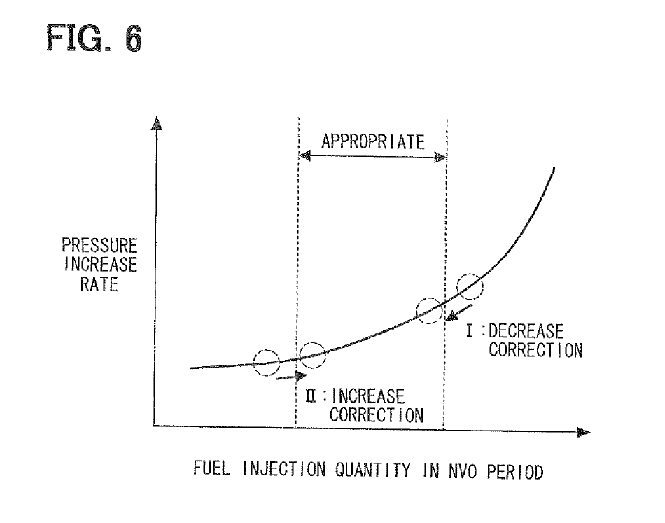

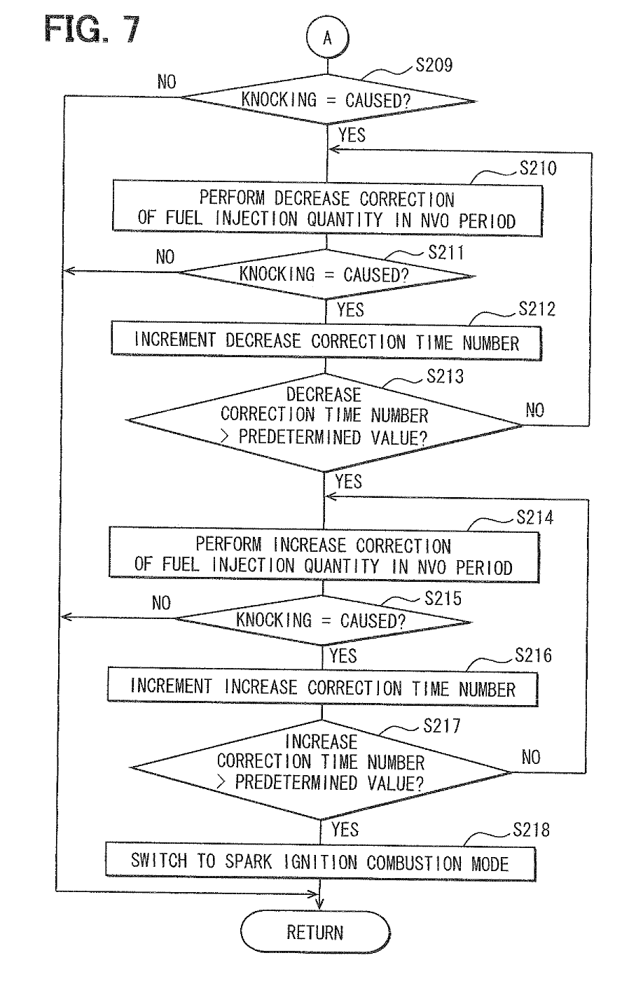

Next, a second embodiment of the present invention will be described with reference to FIGS. 6 and 7. In the following description, differences from the first embodiment will be explained mainly.

In the second embodiment, a routine provided by replacing the processing of FIG. 5 in the combustion control routine of FIGS. 4 and 5 according to the first embodiment with processing shown in FIG. 7 is executed. Thus, when the knocking is detected during the compression self-ignition combustion control, the knock suppression control for correcting the fuel injection quantity in the NVO period such that the knocking is suppressed is performed. At that time, first, it is assumed that the fuel injection quantity in the NVO period is larger than the appropriate range (i.e., combustion is sharp and knocking is caused), and the decrease correction of the fuel injection quantity in the NVO period is performed (as shown by I in FIG. 6). If the knocking is suppressed by the decrease correction, it is determined that the assumption is correct (i.e., fuel injection quantity in NVO period is larger than appropriate range). Then, the fuel injection quantity in the NVO period is maintained at the corrected and decreased state, thereby controlling the fuel injection quantity in the NVO period in the appropriate range. If the knocking cannot be suppressed even though the decrease correction of the fuel injection quantity in the NVO period is performed, it is determined that the assumption is incorrect (i.e., fuel injection quantity in NVO period is smaller than appropriate range). Then, the increase correction of the fuel injection quantity in the NVO period is performed to control the fuel injection quantity in the NVO period into the appropriate range (as shown by II in FIG. 6).

In the routine of FIG. 7, it is determined whether the knocking is caused in S209. If it is determined that the knocking is caused (i.e., knocking exists), processing from S210 related to the knock suppression control is performed as follows.

First, it is assumed that the fuel injection quantity in the NVO period is larger than the appropriate range (i.e., combustion is sharp and knocking is caused) and the fuel injection quantity in the NVO period is corrected and decreased by a predetermined quantity in S210.

Then, the process proceeds to S211, in which it is determined whether the knocking is caused. If it is determined that the knocking is still caused, the process proceeds to S212, in which a count value of the time number of the decrease correction is incremented by one. Then, the process proceeds to S213, in which it is determined whether the count value of the time number of the decrease correction has exceeded a predetermined value. If the count value of the time number of the decrease correction has not exceeded the predetermined value, the process returns to S210 to repeat the processing for further correcting and decreasing the fuel injection quantity in the NVO period by the predetermined quantity.

Thereafter, when it is determined in S211 that the knocking is not caused (i.e., knocking is suppressed), it is determined that the assumption is correct (i.e., fuel injection quantity in NVO period is larger than appropriate range) and that the fuel injection quantity in the NVO period has been corrected into the appropriate range by the decrease correction. Then, the routine is ended. In this case, if the engine 11 is in the steady operation state, the fuel injection quantity in the NVO period after the decrease correction is maintained.

If it is determined in S211 that the knocking is caused and it is determined in S213 that the count value of the time number of the decrease correction has exceeded the predetermined value even though the decrease correction of the fuel injection quantity in the NVO period is performed, it is determined that the assumption is incorrect (i.e., fuel injection quantity in NVO period is smaller than appropriate range). Then, the process proceeds to S214, in which the fuel injection quantity in the NVO period (fuel injection quantity before decrease correction) is corrected and increased by a predetermined quantity.

Then, the process proceeds to S215, in which it is determined whether the knocking is caused. If it is determined that the knocking is still caused, the process proceeds to S216, in which a count value of the time number of the increase correction is incremented by one. Then, the process proceeds to S217, in which it is determined whether the count value of the time number of the increase correction has exceeded a predetermined value. If it is determined that the count value of the time number of the increase correction has not exceeded the predetermined value, the process returns to S214 to repeat the processing for further correcting and increasing the fuel injection quantity in the NVO period by the predetermined quantity.

Thereafter, when it is determined in S215 that the knocking is not caused (i.e., knocking is suppressed), it is determined that the fuel injection quantity in the NVO period has been corrected into the appropriate range by the increase correction, and the routine is ended. In this case, if the engine 11 is in the steady operation state, the fuel injection quantity in the NVO period after the increase correction is maintained.

If it is determined in S215 that the knocking is caused and it is determined in S217 that the count value of the time number of the increase correction has exceeded the predetermined value even though the increase correction of the fuel injection quantity in the NVO period is performed, it is determined that the knocking cannot be suppressed if the compression self-ignition combustion control is maintained. In this case, the process proceeds to S218, in which the combustion mode is compulsorily changed to the spark ignition combustion mode. Thus, the compression self-ignition combustion control is stopped and switched to the spark ignition combustion control to suppress the knocking.

In the above-described second embodiment, during the knock suppression control, first, it is assumed that the fuel injection quantity in the NVO period is larger than the appropriate range and the decrease correction of the fuel injection quantity in the NVO period is performed. If the knocking cannot be suppressed even though the decrease correction of the fuel injection quantity in the NVO period is performed, it is determined that the assumption is incorrect (i.e., fuel injection quantity in NVO period is smaller than appropriate range). Then, the increase correction of the fuel injection quantity in the NVO period is performed to control the fuel injection quantity in the NVO period into the appropriate range. Accordingly, there is no need to obtain the pressure increase rate, and the cylinder pressure sensor 23 can be eliminated. Therefore, requirement for cost reduction can be fulfilled.

In the above-described second embodiment, the decrease correction of the fuel injection quantity in the NVO period is performed first during the knock suppression control, but the present invention is not limited thereto. Alternatively, it may be assumed that the fuel injection quantity in the NVO period is smaller than the appropriate range (i.e., combustion is slow and knocking is caused) and the increase correction of the fuel injection quantity in the NVO period may be performed. When the knocking cannot be suppressed even though the increase correction of the fuel injection quantity in the NVO period is performed, it may be determined that the assumption is incorrect (i.e., fuel injection quantity in NVO period is larger than appropriate range), and the decrease correction of the fuel injection quantity in the NVO period may be performed. Thus, the fuel injection quantity in the NVO period may be controlled into the appropriate range.

In the first and second embodiments, the NVO period is provided by both of the variable valve timing devices on the intake side and the exhaust side. Alternatively, the NVO period may be provided by one variable valve timing device on only either one of the intake side and the exhaust side. Alternatively, the NVO period may be provided by both or either one of variable valve lift devices on the intake side and the exhaust side.

The present invention is not limited to the dual injection engine having both of the injector for the inlet port injection and the injector for the direct injection as shown in FIG. 1. Alternatively, the present invention may be applied to a direct-injection engine having only injectors for the direct injection and implemented.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A controller of an internal combustion engine comprising:
a combustion controlling means for performing compression self-ignition combustion control for combusting a mixture gas by injecting fuel into a cylinder in a negative valve overlapping period, in which both of an exhaust valve and an intake valve are closed at least in a latter half of an exhaust stroke of the internal combustion engine, and by causing self-ignition of the mixture gas using compression in a compression stroke; and
a knock determining means for determining whether knocking is caused during the compression self-ignition combustion control, wherein
when the knock determining means detects the knocking during the compression self-ignition combustion control, the combustion controlling means performs knock suppression control for correcting a fuel injection quantity in the negative valve overlapping period such that the knocking is suppressed.

2. The controller as in claim 1, further comprising:
a pressure increase rate calculating means for calculating an increase rate of cylinder pressure as a pressure increase rate during the combustion while the compression self-ignition combustion control is performed, wherein
the combustion controlling means performs increase correction of the fuel injection quantity in the negative valve overlapping period if the pressure increase rate calculated by the pressure increase rate calculating means is lower than a predetermined threshold value during the knock suppression control, and
the combustion controlling means performs decrease correction of the fuel injection quantity in the negative valve overlapping period if the pressure increase rate is equal to or higher than the threshold value during the knock suppression control.

3. The controller as in claim 1, wherein
the combustion controlling means performs decrease correction of the fuel injection quantity in the negative valve overlapping period when the knock suppression control is performed, and
the combustion controlling means performs increase correction of the fuel injection quantity in the negative valve overlapping period if the knocking cannot be suppressed even though the decrease correction is performed.

4. The controller as in claim 1, wherein
the combustion controlling means performs increase correction of the fuel injection quantity in the negative valve overlapping period when the knock suppression control is performed, and
the combustion controlling means performs decrease correction of the fuel injection quantity in the negative valve overlapping period if the knocking cannot be suppressed even though the increase correction is performed.

5. The controller as in claim 1, wherein
when the knocking cannot be suppressed even through the knock suppression control is performed, the combustion controlling means stops the compression self-ignition combustion control and switches to spark ignition combustion control for combusting the mixture gas by igniting the mixture gas using a spark discharge from a spark plug.
